(19) United States
(12) Patent Application Publication
(10) Pub. No.: US 2017/0061696 A1
(43) Pub. Date: Mar. 2, 2017

(54) VIRTUAL REALITY DISPLAY APPARATUS AND DISPLAY METHOD THEREOF

(71) Applicant: SAMSUNG ELECTRONICS CO., LTD., Suwon-si (KR)

(72) Inventors: Weiming LI, Beijing (CN); Do-wan KIM, Suwon-si (KR); Jae-yun JEONG, Seongnam-si (KR); Yong-gyoo KIM, Seoul (KR); Gengyu MA, Beijing (CN)

(73) Assignee: SAMSUNG ELECTRONICS CO., LTD., Suwon-si (KR)

(21) Appl. No.: 15/252,853

(22) Filed: Aug. 31, 2016

(30) Foreign Application Priority Data
Aug. 31, 2015 (CN) 201510549225.7
Aug. 22, 2016 (KR) 10-2016-0106177

(51) Int. Cl. G06T 19/00; G06T 7/00

(52) U.S. Cl. CPC G06T 19/006; G06T 7/004

(57) ABSTRACT

A virtual reality display apparatus and display method thereof are provided. The display method includes displaying a virtual reality image; acquiring object information regarding a real-world object based on a binocular view of the user; and displaying the acquired object information together with the virtual reality image.

### CROSS-REFERENCE TO RELATED APPLICATIONS

This application claims priority from Chinese Patent Application No. 201510549225.7, filed on Aug. 31, 2015 in the State Intellectual Property Office of the People's Republic of China, and Korean Patent Application No. 10-2016-0106177, filed on Aug. 22, 2016 in the Korean Intellectual Property Office, the disclosures of which are incorporated herein by reference in their entireties.

### BACKGROUND

1. Field

Apparatuses and methods consistent with exemplary embodiments relate to virtual reality or augmented reality.

2. Description of the Related Art

Recently, along with development of virtual reality-related technology and apparatuses, apparatuses that utilize the virtual reality-related technology are in the spotlight. Such a virtual reality apparatus is widely applied in various fields such as entertainment, education, office work, medical care, etc.

A representative example of a virtual reality apparatus is a head-mounted display apparatus, which is also referred to as virtual reality glasses. A head-mounted display apparatus generates and displays a virtual reality image, and a user wears a virtual reality display apparatus and sees the generated virtual reality image. The user may not able to see an actual surrounding environment or an actual object while seeing the virtual reality image through the virtual reality display apparatus. For example, such a case may include an occurrence of a dangerous situation in a surrounding environment, an ingestion of food and drink, or the like. However, it may be inconvenient for the user to take off the virtual reality display apparatus in order to see the actual surrounding environment or the actual object. Also, such an interruption may decrease the user's sense of being immersed in the virtual environment.

Accordingly, there is a need for a method and apparatus for providing reality information to a user even while the user uses the virtual reality apparatus.

### SUMMARY

One or more exemplary embodiments provide a virtual reality display apparatus and a display method thereof.

Further, one or more exemplary embodiments provide a virtual reality display apparatus that may be more convenient and enhance a sense of immersion and a display method thereof.

According to an aspect of an exemplary embodiment, there is provided a display method of a virtual reality display apparatus including: displaying a virtual reality image; acquiring object information regarding a real-world object based on a binocular view of the user; and displaying the acquired object information together with the virtual reality image.

According to an aspect of another exemplary embodiment, there is provided a virtual reality display apparatus including: an object information acquisition unit configured to acquire object information regarding a real-world object based on a binocular view of a user, a display configured to display a virtual reality image and the acquired object information; and a controller configured to control the object information acquisition unit and the display to respectively acquire the object information and display the acquired object information together with the virtual reality image.

According to an aspect of another exemplary embodiment, there is provided a virtual reality headset including: a camera configured to capture a real-world object around a user; a display configured to display a virtual reality image; and a processor configured to determine whether to display the real-world object together with the virtual reality image based on a correlation between a graphic user interface displayed on the display and a functionality of the real-world object.

The processor may be further configured to determine to overlay the real-world object on the virtual reality image in response to determining that the graphic user interface prompts the user to input data and the real-world object is an input device.

The processor may be further configured to determine to display the real-world object together with the virtual reality image in response to a type of the real-world object matching one of a plurality of predetermined types and a current time being within a predetermined time range.

### BRIEF DESCRIPTION OF THE DRAWINGS

The above and/or other aspects will be more apparent by describing certain exemplary embodiments, with reference to the accompanying drawings, in which:

FIG. 1 illustrates an example of using a virtual reality apparatus;

FIGS. 2A and 2B are block diagrams showing an internal configuration of a virtual reality display apparatus according to various exemplary embodiments;

FIG. 3 is a flowchart showing a display method of a virtual reality display apparatus according to an exemplary embodiment;

FIG. 4 is a flowchart showing a method of displaying a physical keyboard in a virtual reality display apparatus according to an exemplary embodiment;

FIG. 5 illustrates an example of requiring a virtual reality display apparatus to display a physical keyboard to a user;

FIG. 6 illustrates a screen for inducing a user to rotate in a direction of a keyboard according to an exemplary embodiment;

FIGS. 7A, 7B, 7C, and 7D illustrate a binocular view of a physical keyboard in a virtual reality display apparatus according to an exemplary embodiment;

FIGS. 8A, 8B, 8C, and 8D illustrates a physical keyboard in virtual reality according to an exemplary embodiment;

FIG. 9 is a flowchart showing a method of displaying food in virtual reality by a virtual reality display apparatus according to an exemplary embodiment;

FIG. 10 illustrates a button according to an exemplary embodiment;

FIG. 11 illustrates a framing operation according to an exemplary embodiment;

FIG. 12 illustrates a screen for selecting an object to be displayed to a user according to an exemplary embodiment;

FIGS. 13A and 13B illustrate a method of avoiding interference between virtual reality and an actual object according to an exemplary embodiment;

FIG. 14 illustrates a method of deleting an actual object displayed in virtual reality according to an exemplary embodiment;

FIG. 15 illustrates a method of displaying a display item in a virtual reality display apparatus according to an exemplary embodiment; and

FIG. 16 illustrates a method of displaying a screen of an external apparatus in a virtual reality display apparatus according to an exemplary embodiment.

### DETAILED DESCRIPTION

Exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions are not described in detail since they would obscure the description with unnecessary detail.

As used herein, the term “and/or” includes any and all combinations of one or more of the associated listed items. Expressions such as “at least one of,” when preceding a list of elements, modify the entire list of elements and do not modify the individual elements of the list.

In this disclosure, when one part (or element, device, etc.) is referred to as being “connected” to another part (or element, device, etc.), it should be understood that the former can be “directly connected” to the latter or “electrically connected” to the latter via an intervening part (or element, device, etc.). Furthermore, when one part is referred to as “comprising” (or “including” or “having”) other elements, it should be understood that it can comprise (or include or have) only those elements or other elements as well as those elements unless specifically described otherwise.

In an exemplary embodiment, a virtual view refers to a view which a user sees in a virtual reality apparatus.

In an exemplary embodiment, a binocular view refers to a view which two eyes of a user who uses a virtual reality apparatus sees.

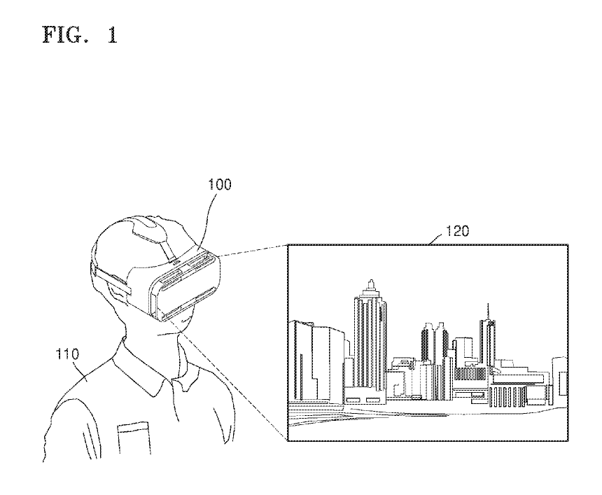

FIG. 1 is a view showing an example of using a virtual reality apparatus.

Referring to FIG. 1, a virtual reality display apparatus 100 provides a user 110 with an image 120 of a virtual space different from a real space in which the user 110 is located.

The virtual reality display apparatus 100 may display the image 120 according to movement of the user 110. The user 110 may move his or her entire body or just his or her head. In this case, the virtual reality display apparatus 100 may display another image according to the movement of the user 110.

According to an exemplary embodiment, the virtual reality display apparatus 100 may be called a head-mounted display, a headset, virtual reality glasses, or the like.

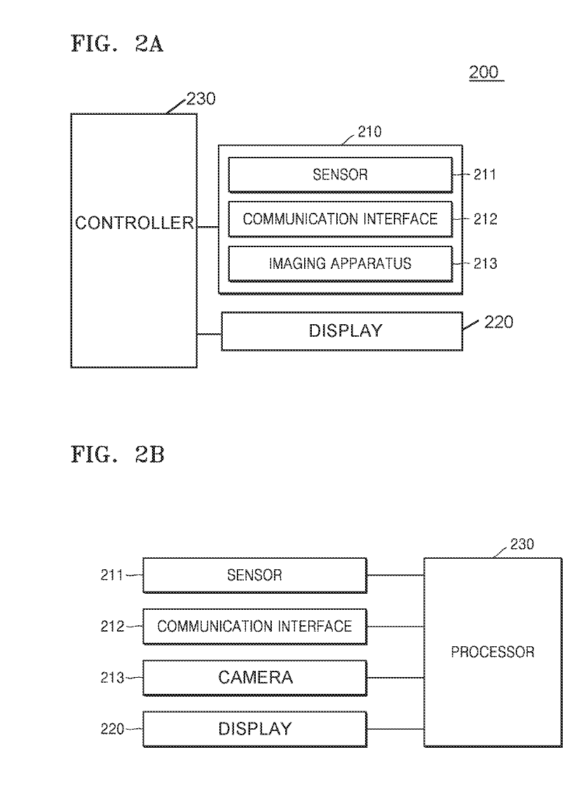

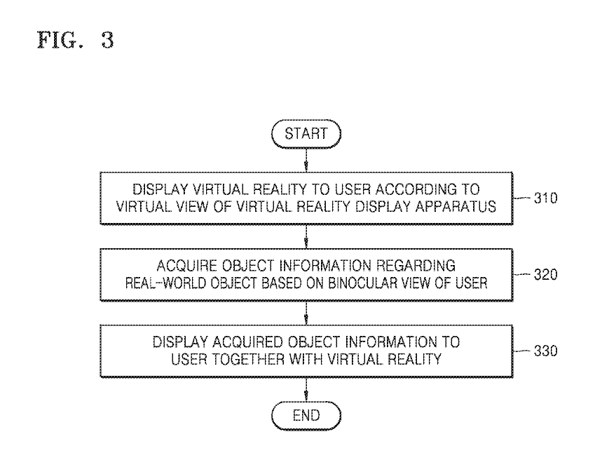

FIG. 2A is a block diagram showing an internal configuration of a virtual reality display apparatus according to an exemplary embodiment.

Referring to FIG. 2A, a virtual reality display apparatus 200 according to an exemplary embodiment may include an object information acquisition unit 210, a display 220, and a controller 230. The object information acquisition unit 210 and the controller 230 may be implemented by one or more processors.

The object information acquisition unit 210 acquires object information regarding a real-world object on the basis of a binocular view of a user. The object information acquisition unit 210 according to an exemplary embodiment may include at least one or more of a sensor 211, a communication interface 212, and an imaging apparatus 213.

The sensor 211 may include various kinds of sensors capable of sensing external information, such as a motion sensor, a proximity sensor, a location sensor, an acoustic sensor, or the like, and may acquire object information through a sensing operation. The communication interface 212 may be connected with a network via wired or wireless communication to receive data through communication with an external apparatus and acquire object information. The communication interface may include a communication module, a mobile communication module, a wired/wireless Internet module, etc. In addition, the communication interface 212 may also include one or more elements. The imaging apparatus 213 may capture an image to acquire the object information. In this case, the imaging apparatus 213 may include a camera, a video camera, a depth camera, or the like, and may include a plurality of cameras.

The display 220 displays virtual reality and the acquired object information. The display 220 may display only the virtual reality or display the virtual reality and the acquired object information together according to control of the controller 230.

The controller 230 may acquire the object information and display the acquired object information together with the virtual reality by controlling an overall operation of the virtual reality display apparatus 200. In this case, the controller 230 may control the display 220 to display object information at a location corresponding to an actual location of the object.

The controller 230 may include a random access memory (RAM) that stores signals or data received from an outside of the virtual reality display apparatus 200 or that is used as a storage area corresponding to various tasks performed by an electronic apparatus, a read-only memory (ROM) that stores a control program for controlling peripheral devices, and a processor. Here, the processor may be implemented as a system on chip (SoC) that integrates a core and a graphics processing unit (GPU). Also, the processor may include a plurality of processors. Furthermore, the processor may also include a GPU.

According to an exemplary embodiment, the controller 230 may acquire object information by controlling the object information acquisition unit 210 to collect data regarding a real-world object. Also, the controller 230 may control the display 220 to process data associated with virtual reality and object information to generate an image and display the generated image.

According to another exemplary embodiment, the virtual reality display apparatus 200 may include a sensor 211, a communication interface 121, a camera 213, a display 220, and a processor 230, as shown in FIG. 2B. The processor 230 may include all of the features of the controller 230 illustrated in FIG. 2A. Similarly, the camera 213 may include all of the features of the imaging apparatus 213 illustrated in FIG. 2A. Alternatively, the camera 213 may captures images of real-world objects and the processor 230 may perform image processing of the real-world objects.

The configuration of the virtual reality display apparatus 200 according to an exemplary embodiment has been described thus far. A display method of the virtual reality display apparatus 200 will be described in greater detail below.

FIG. 3 is a flowchart showing a display method of a virtual reality display apparatus according to an exemplary embodiment.

First, in step 310, the virtual reality display apparatus 200 may display virtual reality to a user according to a virtual view. In an exemplary embodiment, a virtual view refers to a view which the user sees in the virtual reality apparatus. In step 310, as shown in FIG. 1, the virtual reality display apparatus 200 provides the user with an image of a virtual space different from a real space in which the user is located as virtual reality.

Subsequently, in step 320, the virtual reality display apparatus 200 acquires object information regarding a real-world object on the basis of a binocular view of the user. In an exemplary embodiment, a binocular view refers to a view which two eyes of the user who uses the virtual reality apparatus sees. A person may recognize a spatial sense through a view of his or her two eyes. Accordingly, the virtual reality display apparatus 200 may acquire object information regarding a real-world object on the basis of a binocular view of the user in order to provide the user with a spatial sense regarding the object. According to an exemplary embodiment, the object information may include an image of the real-world object. Also, the object information may include depth information of the object and information regarding a location and posture of the object in three-dimensional (3D) space. The virtual reality display apparatus 200 may display the object in virtual reality using the acquired object information, and thus may provide the user with the same experience as that of actually showing the object to the user.

According to an exemplary embodiment, the object may be an object that is configured in advance according to attributes or an application scenario of the object and may include at least one or more of an object in the vicinity of the user, an object with a predetermined label, an object designated by the user, an object that an application running in the virtual reality display apparatus needs to use, and an object required for performing control of the virtual reality display apparatus.

According to an exemplary embodiment, the virtual reality display apparatus 200 may capture an image of the object using the imaging apparatus 213, acquire a different-view image of the object on the basis of the captured image, and acquire a binocular-view image of the object on the basis of the captured image and the different-view image of the object. In this case, the virtual reality display apparatus 200 may perform viewpoint correction on the captured image and the acquired different-view image of the object on the basis of a location relationship between the imaging apparatus 213 and the eyes of the user.

In greater detail, according to an exemplary embodiment, an image of a real-world object may be acquired by a single imaging apparatus, and a binocular-view image for the object may be acquired on the basis of the captured image. The single imaging apparatus may be a general imaging apparatus having a single view. Since an image captured using the single imaging apparatus does not have depth information, a different-view image of the real-world object may be acquired from the captured image. A binocular-view image of the real-world object may be acquired on the basis of the captured image and the different-view image of the real-world object.

According to an exemplary embodiment, the image of the real-world object may be an image of an area where the real-world object is located in an entire captured image. Various image recognition methods may be used to detect an image of an actual object from the capture image.

According to an exemplary embodiment, a binocular-view image of a real-world object may also be acquired on the basis of a stereo image having depth information. In this case, the imaging apparatus 213 may include a depth camera or at least two or more single-view cameras. Here, the at least two or more single-view cameras may be configured to have overlapping fields-of-view.

According to an exemplary embodiment, a single-imaging apparatus, a depth camera, or a single-view camera may be an internal imaging apparatus of the virtual reality display apparatus 200 or may be an external apparatus connected to the virtual reality display apparatus 200, for example, a camera of another apparatus.

Also, according to an exemplary embodiment, when an image of a real-world object predicted to be displayed (also referred to as candidate object) is not detected, the virtual reality display apparatus 200 may widen an imaging angle of view in order to capture an image including the candidate object. Alternatively, when the image of the candidate object is not detected, the virtual reality display apparatus 200 may direct the user to rotate in a direction toward the candidate object to capture an image including the candidate object. For example, the user may be guided to move in the direction toward the candidate object through images, text, audio, or video. According to an exemplary embodiment, the user may be guided to rotate in the direction toward the candidate object on the basis of a pre-stored 3D space location of the candidate object and a 3D space location of the candidate object acquired by a positioning apparatus.

According to an exemplary embodiment, the virtual reality display apparatus 200 may determine whether object information needs to be displayed to a user and acquire the object information when it is determined that the object information needs to be displayed to the user. In particular, for at least one of when a user input to display the object information is received, when it is determined that the object information is set to be displayed to the user, when a control command requiring the object to perform a specific operation is detected on an application interface in virtual reality, when a body part of the user is detected close to the object, when a body part of the user moving in a direction of the object is detected, when it is determined that an application running in the virtual reality display apparatus 200 needs to immediately use the object information, or when it is determined that a time set to interact with the object in the vicinity of the user is reached, the virtual reality display apparatus 200 may determine that the object information needs to be displayed to the user.

For example, when the user performs an input operation using a real-world object (e.g., when the user performs the input operation using a keyboard, a mouse, a handle, etc.), when a collision with a real-world object should be prevented, or when the user grabs a real-world object with his or her hand (e.g., a user eats food or drinks water), the virtual reality display apparatus 200 may determine that the object information needs to be displayed to the user.

In this case, a user input to display the object information may be performed by at least one of a touch screen input, a physical button input, a remote control command, voice control, a gesture, a head movement, a body movement, an eye movement, and a holding operation.

Also, according to an exemplary embodiment, the virtual reality display apparatus 200 may acquire at least one of a notice that an event has occurred and details of the event from an external apparatus. For example, the virtual reality display apparatus 200 may acquire a display item from an Internet of Things (loT) device and may display the acquired display item. In this case, the display item may include at least one of a manipulation interface, a manipulation status, notice information, and instruction information.

Here, the notice information may be text, audio, a video, an image, or other information. For example, when the loT device is a communication device, the notice information may be text information regarding a missed call. Also, when the IoT device is an access control device, the notice information may be a captured monitoring image. Also, the instruction information may be text, audio, a video, or an image used to instruct the user to search for an IoT device. For example, when the instruction information is an arrow sign, the user may acquire a location of an IoT device associated with the user according to a direction indicated by the arrow. The instruction information may be text that indicates a location relationship between the user and the IoT (e.g., a communication device is 2 meters ahead).

According to an exemplary embodiment, the virtual reality display apparatus 200 may acquire a display item of an IoT device in the following processing method. The virtual reality display apparatus 200 may capture an image of the IoT device, search the captured image of the IoT device for a display item of the IoT device, receive the display item of the IoT device from the IoT device inside or outside a field-of-view of a user, detect a location of the IoT device outside the field-of-view of the user through its relationship with the virtual reality display apparatus 200, and acquire the detected location as instruction information. Furthermore, the virtual reality display apparatus 200 may remotely control the IoT device to perform a process corresponding to a manipulation of the user.

According to an exemplary embodiment, when a user wears the virtual reality display apparatus 200, the user may acquire information regarding nearby IoT devices. Also, the user may use the virtual reality display apparatus 200 to remotely control an IoT device to perform a process corresponding to a manipulation of the user.

Furthermore, according to an exemplary embodiment, the virtual reality display apparatus 200 may determine whether to provide the object information to a user on the basis of at least one of importance and urgency of reality information.

Lastly, in step 330, the virtual reality display apparatus 200 may display the acquired object information to the user together with the virtual reality. According to an exemplary embodiment, the virtual reality display apparatus 200 may display the object information at a location corresponding to an actual location of the object. The user may see object information regarding a real-world object in a virtual reality image. In greater detail, the user may see the real-world object in the virtual reality image.

Also, when the virtual reality image and the displayed object information obscure each other, the virtual reality display apparatus 200 may adjust a display method of at least one of the virtual reality image and the object information.

According to an exemplary embodiment, the virtual reality and the object information may be displayed to overlap each other. That is, the object information and the virtual reality image displayed to the user may be spatially combined and displayed. In this case, the user may interoperate with a real-world object which requires feedback in a general virtual reality image of the virtual reality display apparatus 200.

According to an exemplary embodiment, the virtual reality image displayed by the virtual reality display apparatus 200 may be an image that is displayed to a user according to a virtual view of the user in an application running in the virtual reality display apparatus 200. For example, when the application that is currently running in the virtual reality display apparatus 200 is a virtual motion sensing game, for example, boxing or golf, the virtual reality image displayed to the user may be an image according to a virtual view of the user in the game. When the application that is currently running in the virtual reality display apparatus 200 is an application for film screening, the virtual reality image may reflect a virtual film screen scene displayed to the user according to the virtual view of the user.

According to an exemplary embodiment, the virtual reality display apparatus 200 may select one of the following methods to display the acquired object information together with the virtual reality image. That is, the virtual reality display apparatus 200 may spatially combine and display the virtual reality image and the object information, display the object information in the virtual reality image through picture-in-picture (PIP), or display the object information over the virtual reality through PIP.

According to an exemplary embodiment, the object information may be displayed using at least one of translucency, an outline, and a 3D grid line. For example, when a virtual object and the object information in virtual reality image obscure each other in a 3D space, the user is not hindered in seeing the virtual object in the virtual reality image by decreasing shading of the virtual object in the virtual reality image and displaying the object information using at least one of translucency, an outline, and a 3D grid line.

Furthermore, according to an exemplary embodiment, when the virtual object and the object information in the virtual reality image obscure each other in a 3D space, the virtual object may be enlarged or reduced and/or shifted. In this case, it is possible to enlarge or reduce and/or shift all virtual objects in the virtual reality image.

The virtual reality display apparatus 200 may determine a situation in which the virtual object and the object information in the virtual reality image obscure each other in a 3D space and may adjust a display method of the virtual object or the object information. Furthermore, it is possible to adjust the display method of the virtual object or the object information according to an input of the user.

Also, according to an exemplary embodiment, the virtual display 220 may display the virtual reality image without the displayed object information. When the controller 230 determines to stop interoperating with a real-world object, the display 220 may display the virtual reality image without the object information. For example, the display 200 may display the virtual reality image without the object information when at least one of the following events occurs: a user input for preventing display of the object information is received; the controller 230 determines that the object information is set not to be displayed to the user; the controller 230 does not detect a control command requiring the object information to perform a specific operation on an application interface in the virtual reality; the distance between a body part of the user and the object corresponding to the object information is greater than a predetermined distance; a body part of the user is moving in a direction away from the object corresponding to the object information; the controller 230 determines that an application running in the virtual reality display apparatus 200 does not need to use the object information; the controller 230 does not receive, for a predetermined time, a user input that requires an operation using the object information; or the controller 230 determines that the user may perform an operation without seeing the object information.

Here, the user input for preventing the display of the object information may be performed by at least one of a touch screen input, a physical button input, a remote control command, voice control, a gesture, a head movement, a body movement, an eye movement, and a holding operation.

According to an exemplary embodiment, the virtual reality display apparatus 200 may allow the user to smoothly experience virtual reality by adjusting a display method of a virtual object or the object information or by deleting object information and displaying the virtual reality.

Also, according to an exemplary embodiment, when the virtual reality display apparatus 200 acquires at least one of a notice that an event has occurred and details of the event from an external apparatus, the virtual reality display apparatus 200 may display a location of the external apparatus.

Furthermore, according to an exemplary embodiment, the virtual reality display apparatus 200 may determine a method of displaying the object information on the basis of at least one of importance and urgency of reality information, and may display the object information to the user according to the determined display method. In particular, when the virtual object and the real-world object in the virtual reality image obscure each other, the virtual reality display apparatus 200 may determine a display priority to determine the display method. In this case, a display priority list may be predetermined, and the virtual reality display apparatus 200 may classify display priorities of the virtual object and the real-world object in the virtual reality according to importance and urgency. The display priority list may be automatically set by the virtual reality display apparatus 200 or may be set by the user according to a pattern of use.

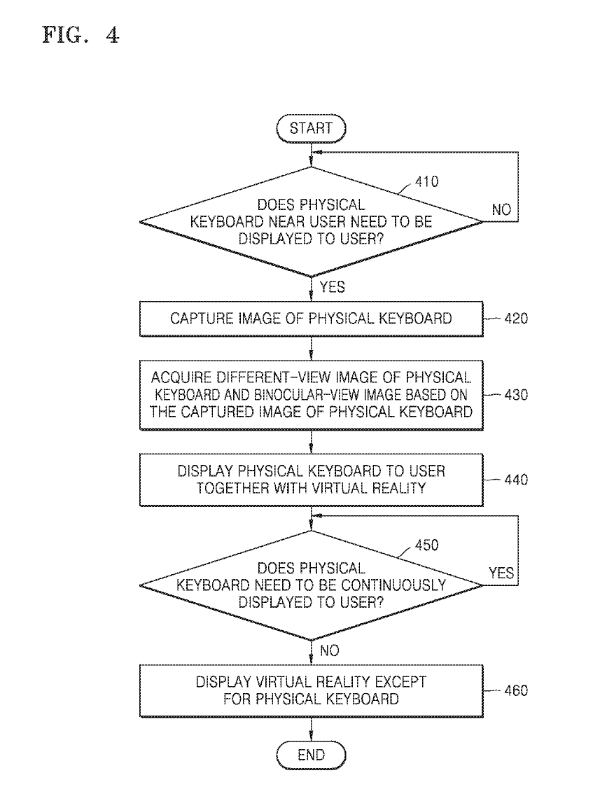

A method of displaying a physical keyboard in the virtual reality display apparatus 200 will be described below with reference to FIGS. 4 to 7 according to an exemplary embodiment.

FIG. 4 is a flowchart showing a method of displaying a physical keyboard in the virtual reality display apparatus 200 according to an exemplary embodiment.

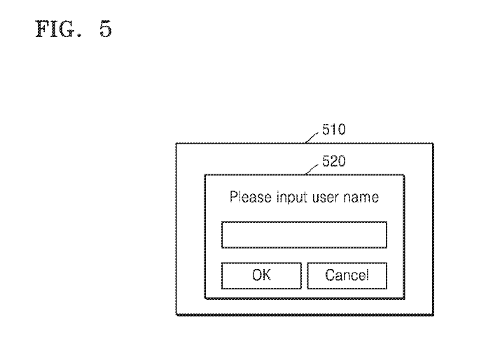

Referring to FIG. 4, in step 410, the virtual reality display apparatus 200 determines whether a physical keyboard in the vicinity of a user needs to be displayed to the user. According to an exemplary embodiment, when a control command that requires an object to perform a specific operation is detected on an application interface in virtual reality, the virtual reality display apparatus 200 may determine that the physical keyboard in the vicinity of the user needs to be displayed to the user. In this case, the virtual reality display apparatus 200 may detect that the corresponding control command is a control command that needs to use an interactive device for performing a specific operation according to attribute information of the control command of the application interface in the virtual reality. When the virtual reality display apparatus 200 detects that there is a control command that needs to use the interactive device for performing the specific operation, the virtual reality display apparatus 200 may determine that an interactive device in the vicinity of the user needs to be displayed. In this case, the physical keyboard may be configured as the interactive device to be displayed to the user. This will be described below with reference to FIG. 5.

FIG. 5 is a view showing an example of requiring the virtual reality display apparatus 200 to display a physical keyboard to a user.

Referring to FIG. 5, a dialog box 520 is displayed to instruct a user to enter text information into the virtual reality display apparatus 200. In this case, the controller 230 may analyze attribute information of a control command of an application interface that instructs the dialog box 520 to be displayed, and may determine that the control command requires the physical keyboard to receive the text information. For example, when the controller 230 receives a control command that enables the display 220 to display an input field (e.g., input field to enter a user name) and/or a selection of inputs (“OK” button and “Cancel” button), the controller 230 may determine that input devices (e.g., mouse, keyboard, etc.) or interactive devices (e.g., touchpad) are candidate real-world objects. Accordingly, when the dialog box 520 is displayed, the virtual reality display apparatus 200 may determine that the physical keyboard needs to be displayed.

Here, as an example, the physical keyboard has been described as an input device to be displayed to the user. However, various devices may be determined as the input device to be displayed to the user according to an application. For example, when the application that is currently running in the virtual reality display apparatus 200 is a virtual game application, a joystick or mouse in addition to the physical keyboard may be the input device to be displayed to the user.

Furthermore, the input device determined to be displayed to the user, that is, the physical keyboard, may be added to and managed in a list of objects to be displayed for future use.

According to another exemplary embodiment, even when a user input requiring a physical keyboard is received, the virtual reality display apparatus 200 may determine that an input device in the vicinity of a user needs to be displayed. Furthermore, when the virtual reality display apparatus 200 receives the user input to prevent the object information from being displayed, the virtual reality display apparatus 200 may display the virtual reality except for the interactive device in the vicinity of the user displayed by the virtual reality display apparatus 200.

Here, the user input to display the object information may be at least one of a touch screen input, a physical button input, a remote control command, voice control, a gesture, a head movement, a body movement, an eye movement, and a holding operation.

According to an exemplary embodiment, the touch screen input or the physical button input may be an input using a touch screen or a physical button provided in the virtual reality display apparatus 200. Also, the remote control command may be a control command received from a physical button disposed at another device (e.g., such as a handle) that may remotely control the virtual reality display apparatus 200. For example, when the virtual reality display apparatus 200 detects an input event of a physical button A, the virtual reality display apparatus 200 may determine that a physical keyboard in the vicinity of a user needs to be displayed to the user. When the virtual reality display apparatus 200 detects an input event of a physical button B, the virtual reality display apparatus 200 may determine that the physical keyboard in the vicinity of the user does not need to be displayed to the user. Also, it is possible to switch to display or not display the physical keyboard through one physical button.

According to an exemplary embodiment, the virtual reality display apparatus 200 may detect a user gesture that instructs the controller 230 to display the physical keyboard on the display 220 and may determine whether the physical keyboard needs to be displayed to the user. For example, when the virtual reality display apparatus 200 detects a gesture A used to indicate that the physical keyboard needs to be displayed, the virtual reality display apparatus 200 may determine that the physical keyboard needs to be displayed. When the virtual reality display apparatus 200 detects a gesture B used to indicate that the physical keyboard does not need to be displayed, the virtual reality display apparatus 200 may determine to not display the physical keyboard. In addition, it is possible to switch to display or not display the physical keyboard through the same gesture.

According to an exemplary embodiment, the virtual reality display apparatus 200 may detect a head movement, a body movement, and an eye movement of the user that instruct to display the physical keyboard through the imaging apparatus 213 and may determine whether the physical keyboard needs to be displayed to the user. For example, the virtual reality display apparatus 200 may detect a head rotation or a line-of-sight of the user and may determine whether the physical keyboard needs to be displayed to the user. For example, when the virtual reality display apparatus 200 detects that the line-of-sight of the user meets a condition A (e.g., a case in which a user sees a dialog box for inducing the user to enter text information in virtual reality), the virtual reality display apparatus 200 may determine that the physical keyboard needs to be displayed to the user. When the virtual reality display apparatus 200 detects that the line-of-sight of the user meets a condition B (e.g., a case in which a user sees a virtual object or a virtual film screen in virtual reality), the virtual reality display apparatus 200 may determine that the physical keyboard does not need to be displayed to the user. Here, the condition A and the condition B may or may not be complementary to each other.

According to an exemplary embodiment, when a hand on the physical keyboard is detected through the imaging apparatus 213, the virtual reality display apparatus 200 may determine that the physical keyboard needs to be displayed to the user. For example, the virtual reality display apparatus 200 detects whether the user's hand is in the vicinity of the user, whether a keyboard is in the vicinity of the user, or whether the user's hand is on the keyboard (e.g., whether a skin color is detected) through the imaging apparatus 213. When all of the above three conditions are met, the virtual reality display apparatus 200 may determine that the physical keyboard needs to be displayed to the user. When any one of the above three conditions is not met, the virtual reality display apparatus 200 may determine that the physical keyboard does not need to be displayed to the user. A condition of whether a user's hand is in the vicinity of the user and a condition of whether a keyboard is in the vicinity of a user may be determined simultaneously or sequentially, and their order is not limited. When it is determined that a user's hand and a keyboard are in the vicinity of the user, the virtual reality display apparatus 200 may determine whether the user's hand is on the keyboard.

Referring back to FIG. 4, in step 410, when the virtual reality display apparatus 200 determines that the physical keyboard need to be displayed to the user, the virtual reality display apparatus 200 proceeds to step 420 and captures an image of the physical keyboard. According to an exemplary embodiment, the virtual reality display apparatus 200 may capture a user vicinity image using the imaging apparatus 213, detect a physical keyboard image from the captured image, and capture the physical keyboard image.

In an exemplary embodiment, the virtual reality display apparatus 200 may detect a feature point in the captured image, compare the detected feature point with a pre-stored feature point of the keyboard image, and detect the physical keyboard image. For example, coordinates of four corners of the physical keyboard may be determined according to the pre-stored feature point of the physical keyboard image and a coordinate of a feature point in the captured image matching a coordinate of the pre-stored feature point of the physical keyboard image. Subsequently, an outline of the physical keyboard may be determined according to the coordinates of the four corners in the captured image. As a result, the virtual reality display apparatus 200 may determine a keyboard image in the captured image. Here, the feature point may be a scale-invariant feature transform (SIFT) or another feature point. Accordingly, a coordinate of a point of an outline of any object (that is, a point on an outline of an object) in the captured image may be calculated in the same or similar method. Furthermore, it should be understood that the keyboard image may be detected from the captured image in another method.

Here, the calculation of the outline of the keyboard in the captured image will be described below in detail using an example of four corner points of the keyboard. A coordinate of a feature point of a pre-stored keyboard image is referred to as P_{world} (in a local coordinate system of a keyboard). A coordinate of an upper left corner on an outline of the pre-stored keyboard image is referred to as P_{corner} (in the local coordinate system of a keyboard). A coordinate of a feature point in the captured image matching a feature point in the pre-stored keyboard image is referred to as P_{image}. Transforms from the local coordinate system of a keyboard to a coordinate system of the imaging apparatus 213 are referred to as R and t. In this case, when R indicates rotation, t indicates shift, and a projection matrix of the imaging apparatus 213 is referred to as K, Equation 1 may be obtained as follows.

P_{image}=K*(R*P_{world}+t) [Equation 1]

The coordinate of the feature point in the pre-stored keyboard image and the coordinate of the feature point in the captured image matching the coordinate of the feature point of the pre-stored physical keyboard image are substituted into Equation 1 to obtain R and t, respectively. Subsequently, a coordinate of an upper left corner in the captured image may be obtained as K*(R*P_{corner}+t). Coordinates of the other three corners of the keyboard in the captured image may also be obtained in the same method. The outline of the keyboard in the captured image may be acquired by connecting the corners. Accordingly, the virtual reality display apparatus 200 may also calculate a coordinate of an outline point of any object in the captured image in order to acquire an outline on which the object in the captured image is projected.

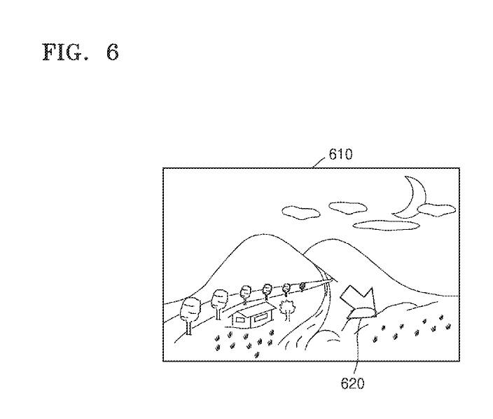

Furthermore, when an image of the physical keyboard is not detected in the captured image, the virtual reality display apparatus 200 may enlarge an imaging angle-of-view and capture a larger image that the previously captured image in order to detect a physical keyboard from the newly captured image (e.g., using an optical angle imaging apparatus). Also, the virtual reality display apparatus 200 may instruct the user to rotate in a direction of the physical keyboard in order to recapture an image including the physical keyboard. This will be described below with reference to FIG. 6.

FIG. 6 is a view showing a screen for inducing a user to rotate in a direction of a keyboard according to an exemplary embodiment.

Referring to FIG. 6, the virtual reality display apparatus 200 may overlay a direction indicating image 620 in a virtual reality image 610 in order to instruct the user to change his/her line-of-sight in a direction of a physical keyboard. In this case, the direction indicating image 620 may include images of an arrow, a finger, etc. In FIG. 6, the direction indicating image 620 is shown using an arrow.

According to an exemplary embodiment, the virtual reality display apparatus 200 may also determine a location of the physical keyboard according to location information that is detected from an image previously captured and stored in the memory or that is detected in a wireless positioning method (e.g., Bluetooth transmission, a radio-frequency identification (RFID) label, infrared rays, ultrasonic waves, a magnetic field, etc.).

In step 430, the virtual reality display apparatus 200 acquires a different-view image of the physical keyboard and a binocular-view image on the basis of the captured physical keyboard image. In an exemplary embodiment, the virtual reality display apparatus 200 may perform viewpoint correction on the captured physical keyboard image and the acquired different-view image of the physical keyboard on the basis of a location relationship between the user's eye and the imaging apparatus 213.

In an exemplary embodiment, the virtual reality display apparatus 200 may perform a homography transform on the detected physical keyboard image according to a rotation and shift relationship between a coordinate system of the user's eye and a coordinate system of the imaging apparatus 213 in order to acquire the binocular-view image of the physical keyboard. The rotation and shift relationship between the coordinate system of the user's eye and the coordinate system of the imaging apparatus 213 may be determined in an offline method or determined by reading and using data provided by a manufacturer.

Also, in an exemplary embodiment, when the imagining apparatus 213 is a single-view imagining apparatus, the virtual reality display apparatus 200 may acquire the different-view image of the physical keyboard on the basis of the captured physical keyboard image. Subsequently the virtual reality display apparatus 200 may perform viewpoint correction on the captured physical keyboard image and the different-view image of the physical keyboard on the basis of a location relationship between the user's eye and the single imaging apparatus 213 to acquire the binocular-view image of the physical keyboard. In this case, since the imaging apparatus 213 is a single-view imagining apparatus, the captured physical keyboard image has only one view. Accordingly, there is a need of a method of transforming a physical keyboard image into a stereo image together with depth information.

According to an exemplary embodiment, the virtual reality display apparatus 200 may acquire a physical keyboard image from another view by performing a calculation on the basis of the physical keyboard image from the current view to acquire the stereo image. For example, the virtual reality display apparatus 200 may use a planar rectangle to generate a model for the physical keyboard. In particular, a location and posture of the physical keyboard in a 3D coordinate system of the single-view imaging apparatus may be acquired on the basis of a homography transformation relationship. When a rotation and shift of the single imaging apparatus and two views of the user's eyes are known, the physical keyboard may be projected on a field-of-view of the user's left eye and a field-of-view of the user's right eye. A binocular view of the user displayed in the virtual reality may be formed to have a stereo effect and a visual cue that reflect an actual posture of the physical keyboard.

Furthermore, according to an exemplary embodiment, the virtual reality display apparatus 200 may approximate an expression form of an object with a more complicated shape using a partial planar model. Also, a similar method may be used to estimate a location and posture of the object. The virtual reality display apparatus 200 may generate a binocular view of the object through the projection.

A physical keyboard image from one view will be used below as an example to describe the calculation of the binocular view of the physical keyboard.

According to an exemplary embodiment, the virtual reality display apparatus 200 may measure in advance or acquire a 3D coordinate of a feature point of the physical keyboard (in the local coordinate system of the keyboard) by capturing a plurality of images and performing a 3D restoration using a stereo visual method. The 3D coordinate of the feature point of the physical keyboard in the local coordination system of the physical point may be referred to as F_{obj}. A coordinate of the feature point of the physical keyboard in a coordinate system of the imaging apparatus 213 may be referred to as P_{cam}. A rotation and a shift from the local coordinate system of the physical keyboard and the coordinate system of the imaging apparatus 213 may be referred to as R and t, respectively. Rotations and shifts of the user's left eye and right eye in the coordinate system of the imaging apparatus 213 may be referred to as Rₗ, tₗ, Rᵣ, and tᵣ. A projection point in a captured image corresponding to the feature point of the physical keyboard may be referred to as P_{img}. Also, an internal parameter matrix K of the imaging apparatus 213 may be acquired through a previous setting.

R and t may be acquired through control of an observed projection point.

P_{img}=K*P_{cam}=K*(P_{obj}*R+t) [Equation 2]

In this case, a projection formula of the left eye is as follows:

P_{left}=K*(F_{obj}*Rₗ+tₗ) [Equation 3]

Since P_{obj} is in one plane, P_{img} and P_{left} satisfy the homography transform. Accordingly, a transform matrix H may be acquired through P_{left}=H*P_{img}. According to the transform matrix H, a captured physical keyboard image I_{cam} may be transformed into an image I_{left} seen by the left eye. An image of the right eye may be acquired in a method similar to the method of acquiring an image of the left eye.

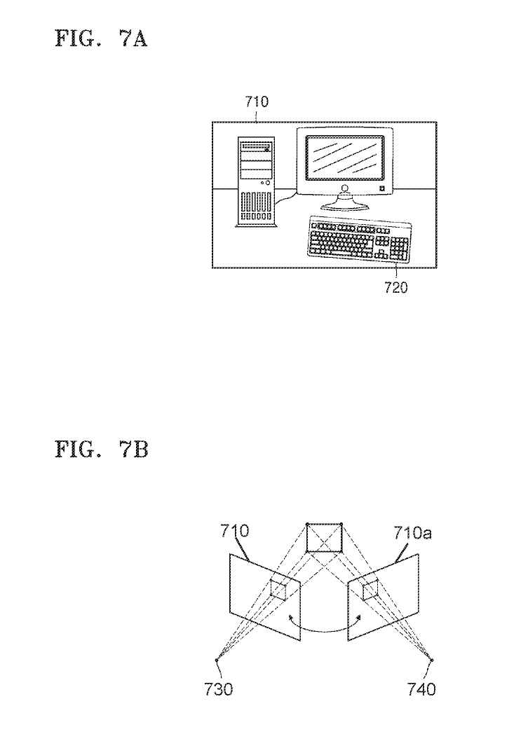

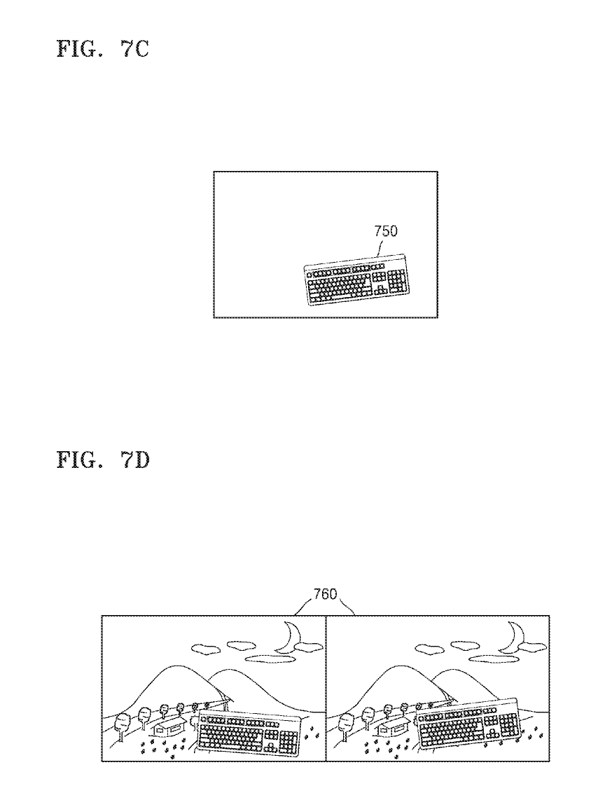

FIGS. 7A to 7D are views showing a binocular view of a physical keyboard on the basis of a physical keyboard image captured by a virtual reality display apparatus according to an exemplary embodiment.

First, as shown in FIG. 7A, the virtual reality display apparatus 200 captures a user vicinity image 710 using the imaging apparatus 213 and detects a physical keyboard image 720 in the user vicinity image 710. In this case, the virtual reality display apparatus 200 may detect a location and posture of the physical keyboard in a 3D space according to a single view. Then, as shown in FIG. 7B, the virtual reality display apparatus 200 captures a nearby image 710a of the user using the imaging apparatus 213 and detects a location and posture of the physical keyboard in a 3D space in a different view 740 from a view 730. According to an exemplary embodiment, the virtual reality display apparatus 200 may perform viewpoint correction on the captured image and the acquired different-view image of the object on the basis of a location relationship between the imaging apparatus 213 and the eyes of the user. FIG. 7C shows a location and posture of a physical keyboard 750 in a 3D space that are detected in the different view 740. Lastly, referring to FIG. 7D, the virtual reality display apparatus 200 may display a binocular view 760 of the physical keyboard acquired through the viewpoint correction in virtual reality.

In the exemplary embodiment of FIG. 7, the method of displaying a binocular view of a physical keyboard in virtual reality using a single-view imaging apparatus 213 has been described. Unlike this, it is also possible to use a depth camera or at least two or more single-view cameras as the imagining apparatus. For example, when the imaging apparatus 213 is a depth camera, a location and posture of a physical keyboard may be acquired from a relationship between a 3D image and the depth camera. Also, when the imaging apparatus 213 includes at least two single-view cameras, a location and posture of a physical keyboard may be acquired through the at least two single-view cameras.

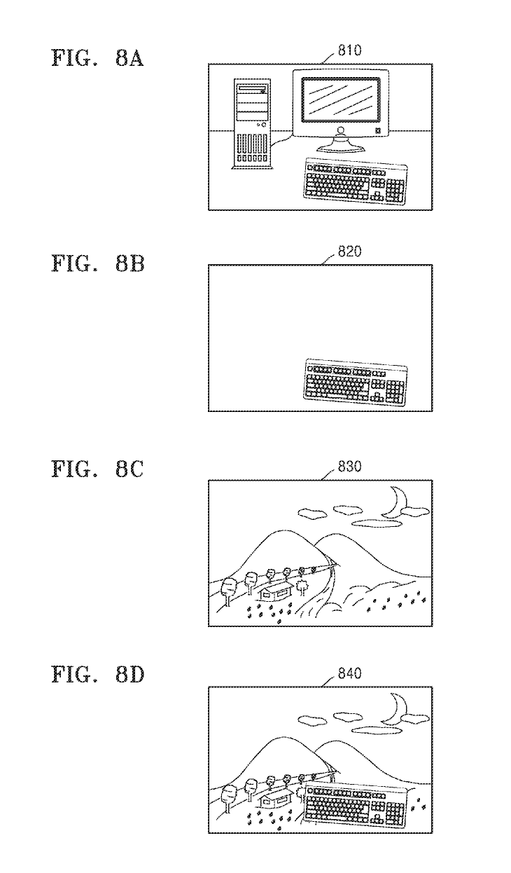

Returning to the description of FIG. 4, in step 440, the virtual reality display apparatus 200 displays an image of the physical keyboard to the user together with the virtual reality image. According to an exemplary embodiment, the virtual reality display apparatus 200 may overlay the physical keyboard on the virtual reality image, or display the physical key board as a picture-in-picture image. This will be described with reference to FIG. 8.

FIGS. 8A to 8D illustrate a physical keyboard in virtual reality according to an exemplary embodiment.

First, as shown in FIG. 8A, the virtual reality display apparatus 200 captures a user vicinity image 810 using the imaging apparatus 213. As shown in FIG. 8B, the virtual reality display apparatus 200 acquires a physical keyboard image 820. Also, as shown in FIG. 8C, the virtual reality display apparatus 200 may display virtual reality 830 separately from the physical keyboard. Lastly, the virtual reality display apparatus 200 displays the physical keyboard in the virtual reality, as shown in FIG. 8D. According to an exemplary embodiment, the virtual reality display apparatus 200 may acquire the physical keyboard image 820 first or may display the virtual reality 830 first.

Returning to the description of FIG. 4, in step 450, the virtual reality display apparatus 200 determines whether the physical keyboard needs to be continuously displayed to the user. In an exemplary embodiment, when the use of the physical keyboard is detected as being finished, the virtual reality display apparatus 200 may determine that the physical keyboard no longer needs to be displayed to the user. For example, the virtual reality display apparatus 200 may continuously detect a keyboard input situation of the user to detect whether the use of the physical keyboard is finished. When the user does not enter any input using the physical keyboard for a predetermined time, the virtual reality display apparatus 200 may detect that the user has finished using the physical keyboard. When a short pause is detected, the virtual reality display apparatus 200 may determine that the user is not finished using the physical keyboard. When the use of the physical keyboard is stopped for a predetermined time or more, the virtual reality display apparatus 200 may determine that the user has finished using the physical keyboard. Here, the predetermined time may be automatically set by the virtual reality display apparatus 200 or may be set by the user. For example, the predetermined time may be 5 minutes.

When the user enters an input using the physical keyboard, the user's hand is not far from the physical keyboard. Accordingly, in an exemplary embodiment, when a distance between the user's hand and the physical keyboard exceeding a predetermined threshold usage distance is detected, the virtual reality display apparatus 200 may determine that the user has finished using the physical keyboard. For example, when a distance between the user's hand and the physical keyboard exceeding a first threshold usage distance is detected, the virtual reality display apparatus 200 may determine that the user has finished using the physical keyboard. In an exemplary embodiment, one hand of the user may be far from the physical keyboard and the other hand may remain on the physical keyboard. Even in this case, the virtual reality display apparatus 200 may determine that the user is no longer using the physical keyboard. Accordingly, when a distance between the user's hand and the physical keyboard exceeding a second threshold usage distance is detected, the virtual reality display apparatus 200 may determine that the user has finished using the physical keyboard.

In an exemplary embodiment, the first threshold usage distance and the second threshold usage distance may be the same or different. Here, the first threshold usage distance and the second threshold usage distance may be automatically set by the virtual reality display apparatus 200 or may be set by the user. Furthermore, a method of measuring the distance between the user's hand and the physical keyboard may be set by the virtual reality display apparatus 200 or may be set by the user.

In an exemplary embodiment, when a user input to stop displaying the physical keyboard is detected as being received, the user may determine that the user has finished using the physical keyboard. The user may enter a signal for stopping the display of the physical keyboard into the virtual reality display apparatus 200 in an input method such as by pressing a specific button. Also, in an exemplary embodiment, when an application running in the virtual reality display apparatus 200 does not require the current physical keyboard, the virtual reality display apparatus 200 may determine that the user has finished using the physical keyboard. For example, when no control command requiring the use of the physical keyboard is detected or when an application needing the physical keyboard is detected as having ended the virtual reality display apparatus 200 may determine that the user has finished using the physical keyboard in order to perform an operation of an application interface in the virtual reality.

Furthermore, in an exemplary embodiment, when switching to another application is detected while the user uses the physical keyboard, the virtual reality display apparatus 200 may determine whether the switched to application needs to use the physical keyboard.

When the virtual reality display apparatus 200 determines that the physical keyboard needs to be continuously displayed to the user in step 450 because, for example, the newly executed application also needs user inputs through the physical keyboard, the virtual reality display apparatus 200 continues to display the physical keyboard to the user.

When the virtual reality display apparatus 200 determines that the physical keyboard does not need to be continuously displayed to the user in step 450, the virtual reality display apparatus 200 proceeds to step 460 and displays the virtual reality except for the physical keyboard. For example, when the sensor 211 detects that the user makes a gesture of swiping left or right at a location where the physical keyboard is displayed in the virtual reality image, the controller 230 may control the display 220 to display the virtual reality image without the physical keyboard.

The method of displaying a physical keyboard in the virtual reality display apparatus 200 has been described as an example thus far. However, exemplary embodiments are not limited thereto, and thus it is possible to display various objects.

For example, the above-described method may also be applied to a handle (e.g., interactive remote controller including various sensors) that is used when a virtual game using the virtual reality display apparatus 200 is played. First, when the virtual reality display apparatus 200 detects an execution situation of a virtual game running therein and determines that the virtual game currently needs to use a handle to operate, the virtual reality display apparatus 200 detects whether the user grabs the handle. The virtual reality display apparatus 200 may display only the virtual game to the user when the user grabs the handle. The virtual reality display apparatus may capture a user vicinity image through the imaging apparatus 213 and may display the handle in the captured image when the user does not grab the handle.

In an exemplary embodiment, the virtual reality display apparatus 200 may detect a temperature and/or humidity around the handle and may determine whether the user grabs the handle. Generally, since a temperature around the user is lower than that of the user's body and humidity of the user's hand is higher than that around the user, the virtual reality display apparatus 200 may include a temperature sensor and/or a humidity sensor provided in the handle and may determine whether the user grabs the handle. In greater detail, the virtual reality display apparatus 200 may determine whether the user grabs the handle through a comparison of a predetermined threshold temperature and/or a threshold humidity with a measured ambient temperature and/or humidity.

In an exemplary embodiment, the virtual reality display apparatus 200 may detect a movement of the handle to determine whether the user grabs the handle. For example, the virtual reality display apparatus 200 may include a motion sensor (a gyroscope, an inertia accelerometer, etc.) to determine whether the user grabs the handle through intensity of the movement, a duration, etc.

In an exemplary embodiment, the virtual reality display apparatus 200 may detect electric current and/or inductance to determine whether the user grabs the handle. Since a human body is an electrical conductor containing moisture, the virtual reality display apparatus 200 may include electrodes provided on a surface of the handle and may measure electric current between the electrodes or measure inductance of each of the electrodes to determine whether the electrode is connected to the user's body.

Also, when the handle is not detected in the captured image, the virtual reality display apparatus 200 may display a notice that no handle is around the user. In this case, the virtual reality display apparatus 200 may display a binocular view of an actual object around the user to the user according to the user's determination to allow the user to find the handle in the vicinity or to switch a situation of an application such that the virtual game may be manipulated without the handle.

When the virtual reality display apparatus 200 detects the handle in the captured image, the virtual reality display apparatus 200 may determine whether the handle is located inside an actual field-of-view of the user (that is, a field-of-view of the user who does not wear the virtual reality display apparatus 200). When the handle is inside the field-of-view of the user, the virtual reality display apparatus 200 may display a binocular view of the handle along with the virtual reality. When the handle is outside the field-of-view of the user, the virtual reality display apparatus 200 may display a notice that no handle is in the current field-of-view of the user. In this case, the virtual reality display apparatus 200 may instruct the user to rotate in a direction in which the handle is located such that the handle may be included in the field-of-view of the user. In an exemplary embodiment, the user may be induced through images, text, audio, or a video.

In an exemplary embodiment, the virtual reality display apparatus 200 may display an inducing box in the virtual reality such that the user may find the handle in the vicinity. The inducing box may induce the user to adjust his or her view according to a location relationship between the handle and the user such that the user may find the handle. Also, the virtual reality display apparatus 200 may induce the user through a voice, an arrow, etc.

The method of displaying a real-world object using the virtual reality display apparatus 200 has been described in detail using an example thus far. According to an exemplary embodiment, the virtual reality display apparatus 200 may be more convenient and may enhance a sense of immersion.

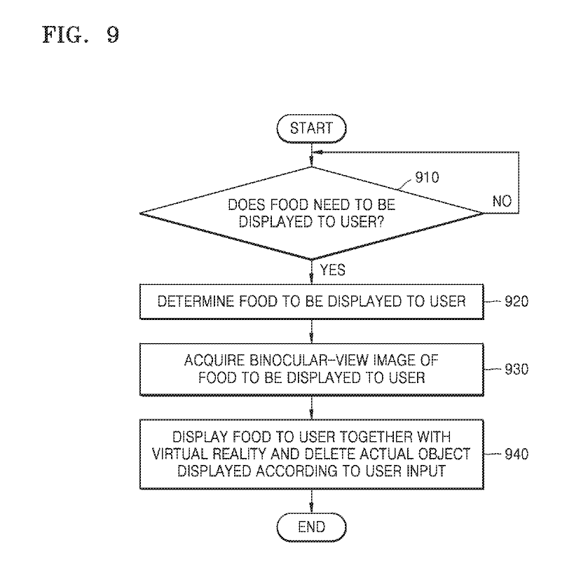

A method of eating food while wearing the virtual reality display apparatus 200 will be described below with reference to FIGS. 9 to 19.

FIG. 9 is a flowchart showing a method of displaying food in virtual reality by a virtual reality display apparatus according to an exemplary embodiment.

Referring to FIG. 9, in step 910, the virtual reality display apparatus 200 determines whether food needs to be displayed to a user.

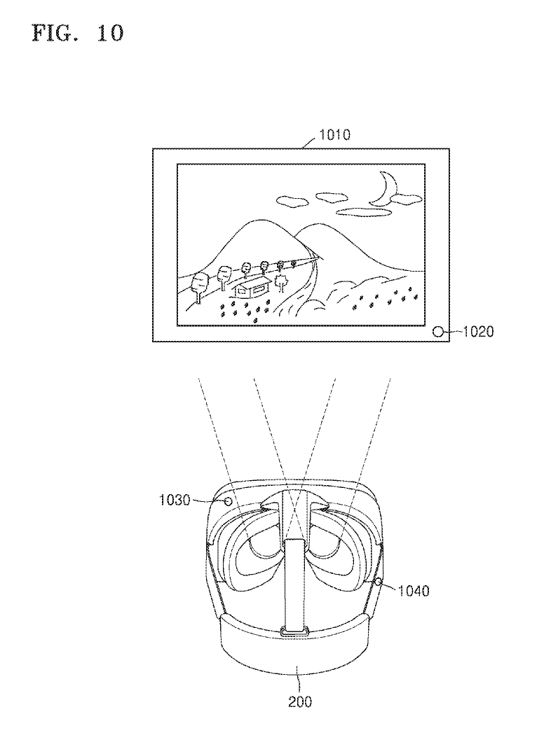

In an exemplary embodiment, when a predetermined button operation is detected, the virtual reality display apparatus 200 may determine that the food needs to be displayed to the user. A button according to an exemplary embodiment will be described with reference to FIG. 10.

FIG. 10 is a view showing a button according to an exemplary embodiment.

Referring to FIG. 10, the button may be a hardware button 1030 or 1040 included on the virtual reality display apparatus 200 or a virtual button 1020 displayed on a screen 1010 of the virtual reality display apparatus 200.

When a user pressing a predetermined button in a predetermined method is detected, the virtual reality display apparatus 200 may determine that food and/or drink need to be displayed to the user. Here, the predetermined method may be at least one of a short press, a long press, a predetermined number of short presses, alternate short and long presses, etc.

Returning to the description of FIG. 9, in an exemplary embodiment, when an object with a specific label is detected around the user, the virtual reality display apparatus 200 may determine whether the object with the specific label needs to be displayed to the user. In this case, all objects needing to be displayed to the user may have the same specific label. Alternatively, other objects needing to be displayed to the user may have different kinds of labels in order to identify different kinds of objects. For example, a first kind of label may be attached to a table in order to identify the table. A second kind of label may be attached to a chair in order to identify the chair. A third kind of label may be attached to a utensil in order to identify the utensil. When the third kind of label is detected around the user, the virtual reality display apparatus 200 may determine that food needs to be displayed to the user. The specific label may be recognized and sensed in various ways.

In an exemplary embodiment, when it is detected that a predetermined meal time is reached, the virtual reality display apparatus 200 may determine that food needs to be displayed to the user. Here, the predetermined meal time may be automatically set by the virtual reality display apparatus 200 and may also be set by the user. When a meal time is automatically set by the virtual reality display apparatus 200 and also a meal time is set by the user, it may be determined that food needs to be displayed to the user according to priorities. For example, when the meal time set by the user has a higher priority than the meal time automatically set by the virtual reality display apparatus 200 and only when the meal time set by the user is reached, the virtual reality display apparatus 200 may determine that the user wants to eat food. It is possible to respond to both of the meal time automatically set by the virtual reality display apparatus 200 and the meal time set by the user.

In an exemplary embodiment, the virtual reality display apparatus 200 may recognize a nearby object in order to determine the type of an actual object. When at least one of food, drink, and a utensil is detected, the virtual reality display apparatus 200 may determine that food needs to be displayed to the user. The virtual reality display apparatus 200 may use an image recognition method to detect food, drink, and a utensil. Furthermore, the virtual reality display apparatus 200 may use other methods to detect food, drink, and a utensil.

In an exemplary embodiment, when at least one of food, drink, and a utensil is detected around the user during the predetermined meal time, the virtual reality display apparatus 200 may also determine that the user wants to eat food. That is, the virtual reality display apparatus 200 may make the determination in consideration of two or more conditions.

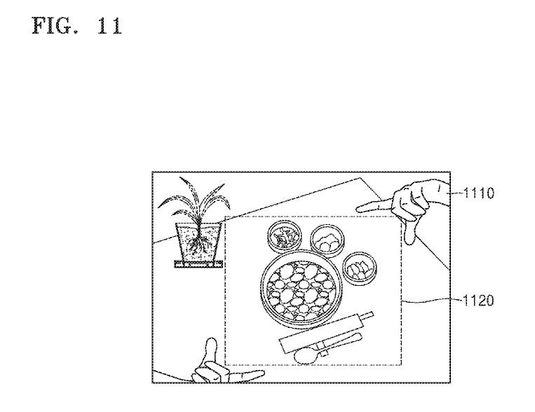

In an exemplary embodiment, when the virtual reality display apparatus 200 detects a predetermined gesture, the virtual reality display apparatus 200 may determine that food needs to be displayed to the user. Here, the predetermined gesture may be made by one or two hands. The predetermined gesture may be at least one of waving a hand, drawing a circle, drawing a quadrangle, drawing a triangle, a framing gesture, etc. Also, when a predetermined posture is detected, the virtual reality display apparatus 200 may determine that food needs to be displayed to the user. Here, the predetermined posture may be at least one of rotating a head, leaning a body to the left, leaning a body to the right, etc. FIG. 11 is a view showing a framing operation according to an exemplary embodiment.

FIG. 11 is a view showing a framing operation according to an exemplary embodiment.

Referring to FIG. 11, the virtual reality display apparatus 200 may determine objects included in a framing area 1120, which is displayed as a quadrangle by a framing gesture of a user 1110, as objects to be displayed to a user. A gesture or posture may be detected through a gesture detection device or a posture detection device.

Returning to the description of FIG. 9, in an exemplary embodiment, when a predetermined remote control command is detected, the virtual reality display apparatus 200 may determine that food needs to be displayed to the user. In particular, the virtual reality display apparatus 200 may detect a remote control command that the user enters into another device and determine that food needs to be displayed to the user. Here, the other device may include at least one of a mobile terminal, a personal computer (PC), a tablet PC, an external keyboard, a wearable device, a handle, etc. Here, the wearable device may include at least one of a smart bracelet, a smart watch, etc. The other device may be connected with the virtual reality display apparatus 200 in a wired or wireless manner. Here, a wireless connection may include Bluetooth, Ultra Wide Band, Zigbee, WiFi, a macro network, etc.

In an exemplary embodiment, when there is a voice control operation, the virtual reality display apparatus 200 may determine that food needs to be displayed to the user. A voice or other sound signals of the user may be collected through a microphone. The virtual reality display apparatus 200 may recognize a voice command or a sound control command of the user using voice recognition technology. For example, when the user makes a voice command “Start eating,” the virtual reality display apparatus 200 may receive and recognize the voice command. In this case, a correspondence relationship between the voice command and a command to display food to the user may be pre-stored in the virtual reality display apparatus 200 in the form of a table. In this case, the virtual reality display apparatus 200 is not bound to a language, and the voice command is also not limited to the above-example, but may be applied in various ways. The voice command may be set by the virtual reality display apparatus 200 and may also be set by the user.

In step 910, when the virtual reality display apparatus 200 determines that food does not need to be displayed to the user, the virtual reality display apparatus 200 determines whether the food needs to be continuously displayed to the user.

In step 910, when the virtual reality display apparatus 200 determines that the food needs to be displayed to the user, the virtual reality display apparatus 200 proceeds to step 920 and determines food to be displayed to the user.

In an exemplary embodiment, the virtual reality display apparatus 200 pre-stores images of various kinds of objects (such as food) and compares a detected image of an actual object with the pre-stored images of food. When the detected image of the actual image matches the pre-stored image of food, the virtual reality display apparatus 200 determines that the actual object detected from the captured image includes the food and determines that the food detected from the captured image is an object to be displayed to the user.

In an exemplary embodiment, the user hopes that as few as possible of actual objects detected from the captured image will be displayed. Accordingly, when the actual object detected from the captured image includes food, the virtual reality display apparatus 200 may separate the food from other actual objects included in the captured image, and the virtual reality display apparatus 200 may determine that only the food is the object to be displayed to the user and may not display the other actual objects to the user. Furthermore, since a relative location between the user's hand and the food may be important to accurately grab the food, the virtual reality display apparatus 200 may detect an image of the user's hand from the captured image according to various algorithms. When the user's hand is detected, the virtual reality display apparatus 200 may determine that the user's hand is the object to be displayed to the user.

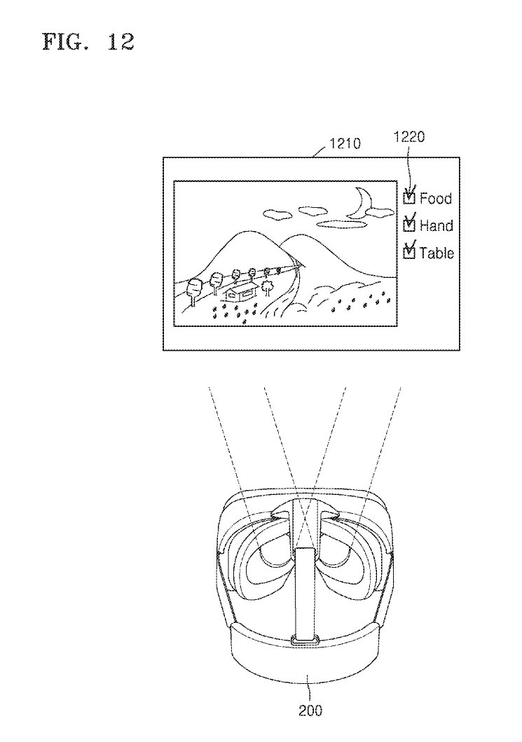

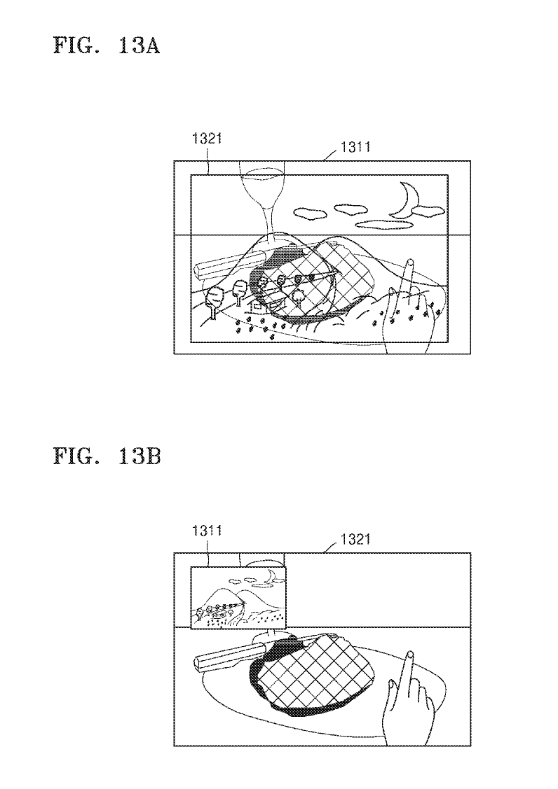

In an exemplary embodiment, the virtual reality display apparatus 200 may use at least one of a label, a gesture, a voice command, and a remote control command to determine the object to be displayed to the user. Also, as shown in FIG. 12, the virtual reality display apparatus 200 may select the object to be displayed to the user.

FIG. 12 is a view showing a screen for selecting an object to be displayed to a user according to an exemplary embodiment.

Referring to FIG. 12, a screen for selecting an object to be displayed to the user through a check box 1220 in a screen 1210 that is displayed in the virtual reality display apparatus 200 is shown. FIG. 12 shows the check box 1220 as a unit for selecting an object, but is not limited thereto. Accordingly, various units for selecting an object to be displayed to the user may be provided.

Also, in an exemplary embodiment, the virtual reality display apparatus 200 may receive a user input through a mouse. Here, the mouse may be a physical mouse and may also be a virtual mouse. The user may manipulate the virtual mouse to select several objects using the check box 1220 in the screen 1210 displayed in the virtual reality display apparatus 200. The virtual reality display apparatus 200 may detect the manipulation and select an object displayed to the user.

Returning to the description of FIG. 9, in step 930, the virtual reality display apparatus 200 acquires a binocular-view image to be displayed to the user. In an exemplary embodiment, a user vicinity image may be captured using the imaging apparatus 213. An image of food to be displayed to the user may be detected from the captured image. A binocular view of food to be displayed to the user may be acquired from the detected image of food to be displayed to the user.

Subsequently, in step 940, the virtual reality display apparatus 200 may display the food to the user together with the virtual reality and may delete a displayed actual object according to the user's input.

In an exemplary embodiment, the virtual reality display apparatus 200 may display the food in the virtual reality such that the food may be superimposed on the virtual reality. In this case, the virtual reality and the food may be covered in a 3D space by each other, and may be displayed in various methods in order to decrease shading and interference between each other.

In an exemplary embodiment, the virtual reality display apparatus 200 may decrease shading and interference between the virtual reality and the food by displaying the food to be displayed in the virtual reality by PIP (that is, displaying a binocular view of a zoomed-out actual object n at a specific location of a virtual scene image), displaying only food without displaying the virtual reality (that is, displaying only a binocular view of an actual object in a virtual scene image as if the user sees the actual object through glasses), displaying the virtual reality by PIP (that is, displaying a zoomed-out virtual scene image at a specific location of a binocular view of food), or spatially combining and displaying the binocular view of the food and the virtual reality (that is, translucently display a binocular view of an actual object over a virtual scene image).

In greater detail, the virtual reality display apparatus 200 may display the food in a translucent manner. In this case, the virtual reality display apparatus 200 may determine whether to display the food in a translucent manner depending on a content type of an application interface displayed in the virtual reality and/or an interaction situation between the application interface and the user. For example, when the user plays a virtual game using the virtual reality display apparatus 200 or when a large amount of user interaction input and frequent shifts in the interface of the virtual game are required, the virtual reality display apparatus 200 may display the food in a translucent manner. Also, when a control frequency of a virtual movie theater or a user's input decreases in an application interface displayed in the virtual reality, the virtual reality display apparatus 200 may finish displaying the food in a translucent manner. In a similar way, the virtual reality display apparatus 200 may also display the food as an outline or a 3D grid line.

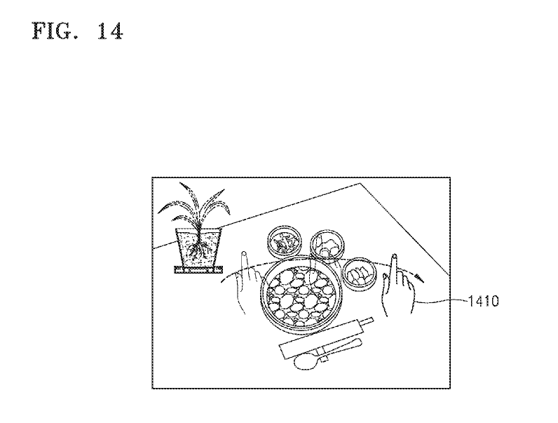

In an exemplary embodiment, at least one of the virtual object and the food may be enlarged or reduced and/or shifted to effectively avoid shading between and the displayed food and the virtual object in the virtual reality. For example, when a virtual movie theater application is executed by the virtual reality display apparatus 200, a virtual screen displayed in the virtual reality may be zoomed out or shifted in order to avoid obscuring the food. This will be described with reference to FIG. 13.

FIGS. 13A and 13B are views showing a method of avoiding interference between virtual reality and an actual object according to an exemplary embodiment.

Referring to FIG. 13A, since virtual reality 1311 and an actual object 1321 including food are displayed obscuring each other, it is difficult for a user to clearly identify the virtual reality image 1311 and the actual object 1321. Accordingly, as shown in FIG. 13B, the virtual reality display apparatus 200 may maintain the size of the actual object 1321 and may zoom out the virtual reality image 1311 to be placed at a corner of the screen. However, this is merely one exemplary embodiment, and thus it is possible to avoid interference between the virtual reality and the actual object in various ways. For example, the actual object 1321 may be zoomed out or shifted.

Returning to the description of FIG. 9, the virtual reality display apparatus 200 may determine a display priority to determine a display method. In this case, a display priority list may be predetermined, and the virtual reality display apparatus 200 may classify display priorities of a virtual object and a real-world object in the virtual reality according to importance and urgency. The display priority list may be automatically set by the virtual reality display apparatus 200 or may be set by the user according to a pattern of use.

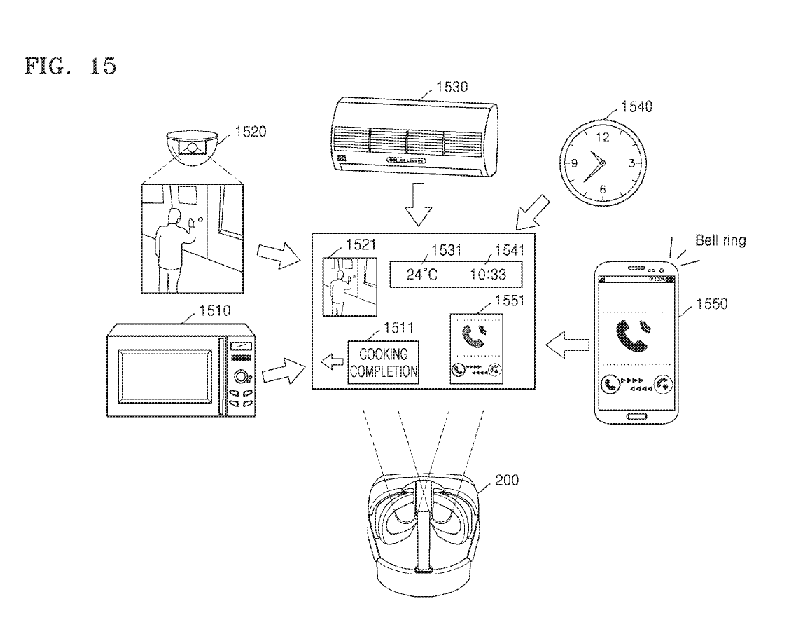

When there are a large number of actual objects around the user, all of the actual objects may be displayed together with the virtual reality, thus hindering the user from seeing the virtual reality. Accordingly, in an exemplary embodiment, the virtual reality display apparatus 200 may receive a user input to select which object in the virtual reality will be displayed or deleted. This will be described below with reference to FIG. 14.

FIG. 14 is a view showing a method of deleting an actual object displayed in virtual reality according to an exemplary embodiment.

Referring to FIG. 14, the virtual reality display apparatus 200 may receive a user input through a gesture 1410 of sweeping an object to be deleted and may delete an actual object being displayed.

In addition, the virtual reality display apparatus 200 may determine whether food needs to be continuously displayed to a user. When it is determined that an actual object no longer needs to be displayed to the user, the virtual reality display apparatus 200 may delete and no longer display a corresponding food. In an exemplary embodiment, the virtual reality display apparatus 200 may detect that the user has finished eating the food and may determine that the food no longer needs to be displayed to the user. In this case, the virtual reality display apparatus 200 may receive a user input through at least one of a button, a gesture, a label, a remote control command, and a voice command and may determine whether the food needs to be continuously displayed to the user.

The method of eating the food while wearing the virtual reality display apparatus 200 has been described in detail using an example thus far. However, the virtual reality display apparatus 200 is not limited thereto and thus may display the virtual reality depending on various situations.

In an exemplary embodiment, a method of preventing a collision with a real-world object while wearing the virtual reality display apparatus 200 will be described.

When the user moves toward a real-world object or a portion of a body approaches the real-world object while the user wears the virtual reality display apparatus 200, a collision between the user and the real-world object may occur.

Accordingly, the virtual reality display apparatus 200 may display a direction in which the user moves or a real-world object which the part of the body is approaching together with the virtual reality in order to prevent such a collision.

First, the virtual reality display apparatus 200 may determine whether there is an object that the user may collide with around the user.

In an exemplary embodiment, the virtual reality display apparatus 200 may acquire an object near the user, a location of the user, an operation, a movement of the user, or the like using at least one of the imaging apparatus 213 and a sensor 211. When the virtual reality display apparatus 200 determines that the user is too close to a nearby object (e.g., when a distance is smaller than a dangerous distance threshold), the virtual reality display apparatus 200 may determine that the object near the user needs to be displayed.

Subsequently, the virtual reality display apparatus 200 may capture an image of the object that the user may collide with, perform viewpoint correction on the image of the object the user may collide with on the basis of a location relationship between the imaging apparatus 213 and the user's eye, generate a binocular view of the object, and display the generated binocular view together with the virtual reality.

In an exemplary embodiment, the object that the user may collide with may be displayed using at least one of translucency, an outline, and a 3D grid line. The virtual reality display apparatus 200 may display only an edge of the object that the user may collide with. Also, the virtual reality display apparatus 200 may remind the user of the object that the user may collide with through text, an image, audio, and a video. For example, the virtual reality display apparatus 200 may display a distance between the user and the object that the user may collide with as inducting information (e.g., in the form of text and/or graphic).

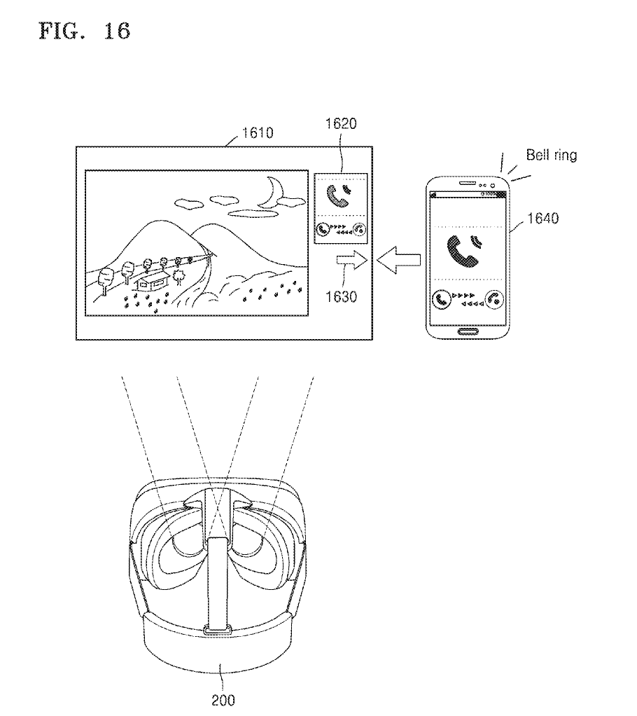

A method of displaying a display item in the virtual reality display apparatus 200 will be described below with reference to FIGS. 15 and 16. In particular, a method of displaying a display item of an external apparatus in the virtual reality display apparatus 200 will be described. By displaying the display item of the external device in the virtual reality display apparatus 200, the user may be aware of information regarding the external apparatus, a task status of the external apparatus, etc.

FIG. 15 is a view showing a method of displaying a display item in a virtual reality display apparatus according to an exemplary embodiment.

Referring to FIG. 15, there may be various external apparatuses, such as a microwave oven 1510, a security camera 1520, an air conditioner 1530, a clock 1540, a mobile terminal 1550, or the like near a user. The virtual reality display apparatus 200 may receive a display item from these external apparatuses and display the received display item in virtual reality 1560. Here, the display item may be an item indicating a manipulation interface, a manipulation state, notice information, indication information, etc. Also, the external apparatus may be an apparatus capable of communicating with the virtual reality display apparatus 200, for example, an IoT apparatus.

In an exemplary embodiment, the virtual reality display apparatus 200 may monitor an actual field-of-view of the user in real time. When the external apparatus comes into the actual field-of-view of the user, the virtual reality display apparatus 200 may acquire a corresponding display item according to the type of the external apparatus. In an exemplary embodiment, the virtual reality display apparatus 200 may use information measured through various kinds of sensors and information such as a facility map of a room in which the user is located in order to monitor the field-of-view of the user in real time. Also, the virtual reality display apparatus 200 may analyze a view of the imaging apparatus 213 installed in the virtual reality display apparatus 200 to acquire the field-of-view of the user.

In an exemplary embodiment, when the virtual reality display apparatus 200 determines that external apparatuses such as the microwave oven 1510, the security camera 1520, the air conditioner 1530, the clock 1540, and the mobile terminal 1550 is detected in the actual field-of-view of the user, the virtual reality display apparatus 200 may acquire and display information corresponding to the external apparatus, for example, a cooking completion notice 1511, a screen 1521 captured by the security camera 1520, a temperature 1531 of the air conditioner 1530, a time 1541, a mobile terminal interface 1551, etc.

In an exemplary embodiment, the virtual reality display apparatus 200 may receive a display item from an external apparatus outside the actual field-of-view of the user and may display the received display item. For example, when a guest arrives at a door, an intelligent doorbell installed in the door may transmit a notice and an image of an outside of the door to the virtual reality display apparatus 200. Also, the virtual reality display apparatus 200 may communicate with a mobile terminal of the user to adjust an interface of the mobile terminal. This will be described with reference to FIG. 16.

FIG. 16 is a view showing a method of displaying a screen of an external apparatus in a virtual reality display apparatus according to an exemplary embodiment.

Referring to FIG. 16, the virtual reality display apparatus 200 may manipulate a display item to remotely control a mobile terminal 1640. In this case, it is assumed that the mobile terminal 1640 and the virtual reality display apparatus 200 communicate with each other.

In an exemplary embodiment, when a phone of the mobile terminal 1640 is ringing, the virtual reality display apparatus 200 may display an interface 1620 of the mobile terminal 1640, and the user may manipulate the interface 1620 of the mobile terminal 1640 displayed in the virtual reality display apparatus 200 to receive a call. When the user decides not to receive the call, the virtual reality display apparatus 200 may receive a user input to disconnect the call directly or may disconnect the call by remotely controlling the mobile terminal 1640. Furthermore, the user may not perform any operation. When the user wants to call again later, the virtual reality display apparatus 200 may be set to call again or may remotely control the mobile terminal 1640 to set a reminder to call again.

Also, in an exemplary embodiment, when the mobile terminal 1640 receives a message requiring a response from the user, the interface 1620 of the mobile terminal 1640 may be displayed in the virtual reality display apparatus 200. The user may manipulate the interface 1620 displayed in the virtual reality display apparatus 200 to respond to the message. When the user wants to reply to the message later, the virtual reality display apparatus 200 may set reply task information or may remotely control the mobile terminal 1640 to set a reply reminder. When the user wants to call a message sender, the virtual reality display apparatus 200 may call the message sender using the virtual reality display apparatus 200 according to the user's manipulation (e.g., when a head-mounted display is used as a Bluetooth earphone).

According to an exemplary embodiment, the virtual reality display apparatus 200 may be convenient and enhance a sense of immersion because the user may manipulate the mobile terminal 1640 using the virtual reality display apparatus 200 while the user wears the virtual reality display apparatus 200 and experience the virtual reality 1610.

Also, in an exemplary embodiment, when the mobile terminal 1640 is present outside the field-of-view of the user, the virtual reality display apparatus 200 may display an indicator 1630 such as an arrow, an indication signal, and text to inform the user of the location of the mobile terminal 1640. Furthermore, when the user finishes using the mobile terminal 1640, the virtual reality display apparatus 200 may also remove and no longer display the display item.

Returning to the description of FIG. 15, the virtual reality display apparatus 200 may display an acquired display item in various ways. In an exemplary embodiment, the display item may be displayed and superimposed on the virtual reality. However, such a method is merely one exemplary embodiment, and the display item may be displayed according to an appropriate layout such that the user may better interact with the external device. It may be considered that the interaction between the user and the virtual reality and the interaction between the user and the external apparatus are performed at the same time.

Furthermore, the virtual reality display apparatus 200 may also select a kind of a display item to be displayed. In an exemplary embodiment, external apparatuses may be listed and managed as a list. The virtual reality display apparatus 200 may display only a display item acquired from an external apparatus selected from the list according to the user's input. Also, detailed settings for the external apparatus are possible. For example, types of messages that may be received from the external apparatus may be listed and managed as a list. The virtual reality display apparatus 200 may display only a message selected according to the user's input.

In addition, the virtual reality display apparatus 200 may set a blocking level that allows information to be received according to whether an application running in the virtual reality display apparatus 200 is hindered and may display the display item according to the set level. For example, when an application (e.g., an intense fight in a real-time virtual network game) is not hindered during the execution of the application, the virtual reality display apparatus 200 may set the blocking level to be high and may display the display item in a method that has as little influence as possible. An application with a low blocking level may freely display the display item. It is also possible to set a plurality of blocking levels according to a single application situation.

While not restricted thereto, the operations or steps of the methods or algorithms according to the above exemplary embodiments may be embodied as computer-readable codes on a computer-readable recording medium. The computer-readable recording medium may be any recording apparatus capable of storing data that is read by a computer system. Examples of the computer-readable recording medium include read-only memories (ROMs), random-access memories (RAMs), CD-ROMs, magnetic tapes, floppy disks, and optical data storage devices. The computer-readable recording medium may be a carrier wave that transmits data via the Internet, for example. The computer-readable medium may be distributed among computer systems that are interconnected through a network so that the computer-readable code is stored and executed in a distributed fashion. Also, the operations or steps of the methods or algorithms according to the above exemplary embodiments may be written as a computer program transmitted over a computer-readable transmission medium, such as a carrier wave, and received and implemented in general-use or special-purpose digital computers that execute the programs. Moreover, it is understood that in exemplary embodiments, one or more units of the above-described apparatuses and devices can include or implemented by circuitry, a processor, a microprocessor, etc., and may execute a computer program stored in a computer-readable medium.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display method of a virtual reality display apparatus, the display method comprising:
displaying a virtual reality image;
acquiring object information regarding a real-world object based on a binocular view of a user; and
displaying the acquired object information together with the virtual reality image.

2. The display method of claim 1, wherein the displaying the acquired object information together with the virtual reality image comprises displaying the object information in the virtual reality image at a location corresponding to an actual location of the object.

3. The display method of claim 1, wherein the acquiring object information regarding the real-world object comprises:
capturing a first image of the real-world object using an imaging apparatus;
acquiring a second image of the real-world object, which has a view different from a view of the first image, based on the captured first image; and
acquiring a binocular-view image of the real-world object based on the first image and the second image of the real-world object.

4. The display method of claim 3, wherein the acquiring the binocular-view image comprises performing viewpoint correction on the first image and the second image of the real-world object based on a location relationship between an eye of the user and the imaging apparatus.

5. The display method of claim 1, wherein the displaying the acquired object information comprises determining whether to provide the object information to the user based on at least one of importance and urgency of reality information.

6. The display method of claim 5, wherein the displaying the acquired object information together with the virtual reality image comprises:
determining a display method for displaying the object information based on at least one of the importance and the urgency of the reality information; and
displaying the object information according to the determined display method.

7. The display method of claim 1, wherein the displaying the acquired object information together with the virtual reality image comprises adjusting a display method for at least one of the virtual reality image and the object information in response to the virtual reality image and the object information obscuring each other.

8. The display method of claim 1, wherein the acquiring the object information comprises:
determining whether the object information needs to be displayed to the user; and
acquiring the object information when it is determined that the object information needs to be displayed.

9. The display method of claim 8, wherein the determining whether the object information needs to be displayed to the user comprises determining that the object information needs to be displayed to the user when a user input requiring the object information to be displayed is received, when the object information is set to be displayed to the user, when a control command requiring the real-time object to perform a specific operation is detected on an application interface in the virtual reality image, when a distance between a body part of the user and the object is less than a first threshold distance, when a body part of the user is moving in a direction of the object, when an application running in the virtual reality display apparatus needs to immediately use the object information, or when a time set to interact with the real-world object within a second threshold distance from the user is reached.

10. The display method of claim 1, further comprising displaying the virtual reality without the displayed object information.

11. The display method of claim 10, wherein the displaying the virtual reality without the displayed object, comprises removing the displayed object information when a user input for preventing the object information from being displayed is received, when the object information is not set to be displayed to the user, when a control command requiring the object information to perform a specific operation is not detected on an application interface in the virtual reality, when a distance between a body part of the user and the real-time object is greater than the second threshold distance, when a body part of the user is moving in a direction away from the real-world object, when an application running in the virtual reality display apparatus does not need to use the object information, when the user does not perform an operation using the object information for a predetermined time, or when it is determined that the user is able to perform an operation without seeing the object information.

12. The display method of claim 1, wherein the acquiring the object information comprises acquiring the information regarding at least one of an object present within a predetermined distance from the user, an object with a predetermined label, an object designated by the user, an object an application running in the virtual reality display apparatus needs to use, and an object required for performing control of the virtual reality display apparatus.

13. The display method of claim 1, wherein the acquiring the object information comprises acquiring at least one of a notice that an event has occurred and details of the event from an external apparatus.

14. The display method of claim 13, wherein the displaying the acquired object information together with the virtual reality image comprises displaying a location of the external apparatus.

15. A virtual reality display apparatus comprising:
an object information acquisition unit configured to acquire object information regarding a real-world object based on a binocular view of a user;
a display configured to display a virtual reality image and the acquired object information; and
a controller configured to control the object information acquisition unit and the display to respectively acquire the object information and display the acquired object information together with the virtual reality image.

16. The virtual reality display apparatus of claim 15, wherein the object information acquisition unit includes at least one of a sensor, a communication interface, and an imaging apparatus.

17. The virtual reality display apparatus of claim 15, wherein the controller controls the display to display the object information at a location corresponding to an actual location of the real-world object.

18. A virtual reality headset comprising:
a camera configured to capture a real-world object around a user;
a display configured to display a virtual reality image; and
a processor configured to determine whether to display the real-world object together with the virtual reality image based on a correlation between a graphic user interface displayed on the display and a functionality of the real-world object.

19. The virtual reality headset of claim 18, wherein the processor is further configured to determine to overlay the real-world object on the virtual reality image in response to determining that the graphic user interface prompts the user to input data and the real-world object is an input device.

20. The virtual reality headset of claim 18, wherein the processor is further configured to determine to display the real-world object together with the virtual reality image in response to a type of the real-world object matching one of a plurality of predetermined types and a current time being within a predetermined time range.
